(19) United States
(12) Patent Application Publication
(10) Pub. No.: US 2004/0013965 A1
(43) Pub. Date: Jan. 22, 2004

(54) Sensitivity enhancement of radiation-sensitive elements

(76) Inventors: Livia T. Memetea, Coquitlam (CA); Jonathan W. Goodin, Tyler, TX (US); Nicholas Bradford, Richmond (CA); Juana G. Jaramillo, Coquitlam (CA); Cheng Yang, Coquitlam (CA)

Correspondence Address: David J. McGruder, OYEN WIGGS GREEN & MUTALA, Suite 480 - The Station, 601 West Cordova Street, Vancouver, BC, V6B 1G1, CA

(21) Appl. No.: 10/388,488

(22) Filed: Mar. 17, 2003

Related U.S. Application Data
(60) Provisional application No. 60/364,078, filed on Mar. 15, 2002.

(51) Int. Cl. G03C 1/52

(52) U.S. Cl. 430/165; 430/189

(57) ABSTRACT

A positive photosensitive composition for use with a radiation source comprises one or more polymers capable of being dissolved in an alkaline aqueous solution and a compound which, upon being heated, releases gas. The composition is stable in its state before exposure and has an excellent handling property. The sensitivity of a recording layer based on the composition of this invention is increased without compromising the handling characteristics. In addition radiation sensitive-elements based on the composition of the invention have good development latitude.

### CROSS-REFERENCE TO RELATED APPLICATION

This application claims the benefit of provisional application No. 60/364,078 filed Mar. 15, 2002.

### FIELD OF THE INVENTION

The invention pertains to the field of radiation-sensitive compositions and, in particular, to their use in lithography.

### BACKGROUND OF THE INVENTION

Lithographic processes involve establishing image (printing) and non-image (non-printing) areas on a substrate, substantially on a common plane. When such processes are used in printing industries, non-image areas and image areas are arranged to have different affinities for printing ink. For example, non-image areas may be generally hydrophilic or oleophobic and image areas may be oleophilic.

Electronic parts whose manufacture may use a radiation-sensitive composition include printed circuit boards (PCBs), thick-and thin-film circuits, comprising passive elements such as resistors, capacitors and inductors; multichip devices (MDCs); integrated circuits (ICs); and active semiconductor devices. The electronic parts may suitably comprise conductors, for example copper board; semiconductors, for example silicon, germanium or Group III-V materials; and insulators, for example silica, as a surface layer with silicon beneath, with the silica being selectively etched away to expose portions of the silicon beneath (a step in the manufacture of e.g. field effect transistors). In relation to masks, a required pattern may be formed in the coating on the mask precursor, for example a plastic film, which is then used in a later processing step, in forming a pattern on, for example, a printing or electronic part substrate.

Conventionally, laser direct imaging methods (LDI) have been known which directly form an offset printing plate or printed circuit boards (PCB) on the basis of digital data from a computer. LDI offers the potential benefits of better line quality, just-in-time processing, improved manufacturing yields, elimination of film costs, and other recognized advantages. Examples of such methods include: (1) an electrophotographic method, (2) a photopolymerization method based on the combination of exposure by an Argon laser and post-heating, (3) a method in which a silver salt sensitive material is deposited on a photosensitive resin, (4) a method using a silver master and (5) a method in which a silicone rubber layer is decomposed by discharge breakdown or a laser beam.

However, in the electro-photographic method (1), processing such as charging, exposure and development are complicated, and the device used for the processing is also complex and large. In method (2), the post-heating step is required. Further, a highly sensitive plate material is also required, and handling thereof in a light room is difficult. In methods (3) and (4), silver salts are used and thus the processing in these methods is complicated and the cost is high. Method (5) is a relatively complete method, but there remains a problem in that silicone dust remaining on the surface of the offset printing plate must be removed.

Thermally-sensitive imaging elements are classified as compositions that undergo chemical transformation(s) in response to exposure to, and absorption of, suitable amounts of heat energy. The nature of thermally-induced chemical transformation may be to ablate the composition, or to change the solubility of the composition in a particular developer, or to change tackiness of the surface, or to change the hydrophilicity or the hydrophobicity of the surface of the thermally-sensitive layer. As such, selective heat exposure of predetermined areas (imagewise distribution of heat energy) of a film or layer formed of a thermally-sensitive composition has the capability of directly or indirectly producing a suitably imaged pattern of composition which can serve as a resist pattern in PCB fabrication, or in production of lithographic printing plates.

Conventional positive working systems based on novolak-diazoquinone resins are the main imaging material of the computer chip industry (see, e.g. R. R. Dammel, “Diazonaphthoquinone-based Resists”, Tutorial text No. 11, SPIE Press, Bellingham. Wash., 1993).

Compositions of light sensitive novolak-diazoquinone resins are also widely used in the printing plate fabrication. The light sensitive diazonaphthoquinone derivatives (DNQ) added to novolak resins (a phenol-formaldehyde condensation polymer) slows down the dissolution of the resin. A revised molecular mechanism of novolak-DNQ imaging materials has been published (A. Reiser, Journal of Imaging Science and Technology, Volume 42, Number 1, January/February 1998, pp. 15-22) and teaches that the basic features of the imaging phenomena in novolak-diazonaphthoquinone compositions is the observed inhibition of dissolution of the resin, which inhibition is based on the formation of phenolic strings by the interaction of the strong hydrogen acceptor which acts as a solubility inhibitor with the OH groups of the resin. On exposure, the hydrogen bonding between the phenolic strings is severed during a reaction known as the Wolff rearrangement, which follows photolysis of the diazoquinone moiety of the inhibitor molecule. This rearrangement is not only very fast, but also highly exothermic. At the high temperature that is produced at the location of the solubility inhibitor, the phenolic string is severed from its anchor at the DNQ and becomes inactive (dispersed), because it is no longer held together by the inductive effect of the solubility inhibitor.

This model also explains the fact that a wide range of heat sensitive compositions, based on novolak resins wherein different types of inhibitors were incorporated, have appeared in patent literature and in commercial announcements. For example, positive-working direct laser addressable printing form precursors based on phenolic resins sensitive to UV, visible and/or infrared radiation have been described (see, e.g. U.S. Pat. No. 4,708,925; U.S. Pat. No. 5,372,907; U.S. Pat. No. 5,491,046. In U.S. Pat. No. 4,708,925, the phenolic resin dissolution in alkaline solution was decreased by a radiation-sensitive onium salt, such as triphenylsulfoniumhexafluorophosphate, instead of DNQ, with the native solubility of the resin being restored upon photolytic decomposition of the onium salt. The onium salt composition is intrinsically sensitive to UV radiation and can be additionally sensitized to infrared radiation.

U.S. Pat. Nos. 5,372,907 and 5,491,064 utilize direct positive-working systems based on a radiation-induced decomposition of a latent Bronsted acid to increase the solubility of the resin matrix on imagewise exposure. The described compositions can be additionally utilized as a negative-working system with additional processing after imaging and predevelopment. The onium salts, the quinonediazide compounds or the like are not necessarily highly compatible with the alkali aqueous solution soluble polymer compound or the material that absorbs light to generate heat. Thus, it is difficult to prepare a uniform coating solution and to obtain a uniform and stable material for laser direct imaging. In U.S. Pat. Nos. 6,037,085 and 5,962,192 thermal laser-sensitive compositions are described based on azide-materials wherein a dye-component is added to obtain the requisite sensitivity.

A wide range of thermally-induced compositions useful as thermographic recording materials are disclosed in patent GB 1,245,924, whereby the solubility of any given area of the imageable layer in a given solvent can be increased by the heating of the layer by indirect exposure to a short duration high intensity visible light and/or infrared radiation transmitted or reflected from the background areas of a graphic original located in contact with the recording material. Several systems are described which operate by many different mechanisms and use different developing materials ranging from water to chlorinated organic solvents. Included in the range of compositions disclosed which are aqueous developable, are those which comprise a novolak type phenolic resin. The patent describes that coated films of such resins show increased solubility on heating. The compositions may contain heat-absorbing compounds such as carbon black or Milori Blue (C.I. Pigment Blue 27); these materials additionally color the images for their use as a recording medium.

Other compositions which include dissolution-inhibiting materials are described in the patent literature. Examples include WO 97/39894, WO 98/42507, WO99/08879, WO99/01795, WO99/21725, U.S. Pat. Nos. 6,117,623, 6,124,425, EP 940266 and WO 99/11458. However, the IR dye or the like functions only as a dissolution-inhibiting agent in the non-exposed portions (the image portions), and does not promote the dissolution of the binder resin in the exposed portions (the non-image portions).

Several materials capable of increasing the sensitivity of positive-working compositions have been described. Cyclic anhydrides as sensitisers are described in U.S. Pat. No. 4,115,128; examples include phthalic anhydride, succinic anhydride and pyromellitic anhydride. Phenols and organic acids have also been described in JP-A Nos. 60-88942 and 2-96755. Specific examples include bisphenol A, 2,3,4-trihydroxybenzophenone, 4-hydroxybenzophenone, p-toluenesulfonic acid, dodecylbenzenesulfonic acid, phenyl phosphate, diphenyl phosphate, benzoic acid, isophthalic acid, adipic acid, terephthalic acid, lauric acid, and ascorbic acid or the like. However, all these materials increase the solubility of the non-exposed portion of the coating, resulting in a reduction in the robustness of the imageable composition to the development process.

Heat-sensitive compositions in which materials are added to increase the sensitivity of the compositions that do not substantially change the developability of the unexposed coating are not described by the current state of the art.

### SUMMARY OF THE INVENTION

A positive photosensitive composition for use with a radiation source comprises one or more polymers capable of being dissolved in an alkali aqueous solution and a compound which, upon being heated, releases gas. The composition is stable in its state before exposure and has excellent handling properties. The sensitivity of a recording layer formed of the composition of this invention is increased without compromising the handling characteristics.

According to a first broad aspect of the invention, there is provided a radiation-imageable composition comprising a polymer and a sensitizing compound that, upon being heated, increases the rate at which the polymer dissolves in an aqueous alkaline developer. The sensitizing compound is gas-forming. It is preferred to include a light-to-heat converting compound in the composition to match the sensitivity range of the composition to the wavelength of incident radiation.

According to a second broad aspect of the invention, there is provided a radiation-sensitive element having a coating of a composition as aforesaid.

In a further aspect of the invention, there is provided a positive-working lithographic printing precursor having a coating comprising the composition as aforesaid that is imageable by radiation, preferably infrared radiation, and is developable using an alkaline aqueous developer solution.

In a further aspect of the invention, there is provided a positive-working lithographic printing master comprising a precursor as aforesaid, imaged and developed.

### DETAILED DESCRIPTION OF THE PREFERRED EMBODIMENT

According to the present invention, a positive radiation-sensitive composition for use with a radiation source comprises, as component (A), one or more polymer compounds capable of being dissolved in an alkali aqueous solution, and a compound, referred to herein as a sensitizing compound, which releases gas upon being heated, as component (B).

The polymer component (A) has some degree of solubility in alkaline aqueous solution, though preferably a low degree. In an image-recording coating formed from the compositions of the invention, the polymer has low solubility due either to its inherently low solubility or due to interaction with other materials in the composition, for example based on hydrogen bonding or the like. When the recording layer (the coating) absorbs radiation, due to the presence of the sensitizer compound, a gas is liberated which forms small vesicles within the coating that permit the aqueous developer to percolate more easily through the coating, increasing the rate of dissolution of the coating in the aqueous alkaline developer. The result is a decrease in the amount of energy needed in exposing the composition to obtain a desired level of developability. Areas of the composition that are not exposed to the radiation (and are therefore not heated by it) do not exhibit significant change in the rate of dissolution in developer.

It is to be understood that an increase in the rate of dissolution of the coating means, for purposes of the invention, an increase that is an amount useful in the image-forming process. It does not include any increase that is less than a useful amount.

The invention provides a positive photosensitive composition for use with a radiation source in lithographic applications, such as conventional imaging systems, computer-to-plate systems or other direct imaging elements and applications. It is stable in its state before exposure and has excellent handling properties.

It is to be understood that the polymer compounds that are component (A) have some, though preferably low, solubility in the alkaline aqueous solution in the non-irradiated (i.e. unheated) areas of the coating, and higher solubility in the irradiated areas, due to the action of the sensitizer. It is this differential in solubility that permits developability of the image that is formed by the radiation. Without wishing to be bound by any theory, it is believed that the higher rate of dissolution of the polymer in the treated areas may be due to the greater surface area of the polymer resulting from the action of the generated gas, or by action of generated heat.

One important component of the practice of the present invention is the selection of the thermally sensitive polymer component for the positive-acting resist layer. In one preferred embodiment of the present invention, the polymer used as component (A), is a polymer compound having in the molecule any one of a phenolic hydroxide group, a sulfonamide group, and an active imide. The polymer compound having the phenolic hydroxide group may, for example, be a novolak resin such as phenol formaldehyde resin, m-cresol formaldehyde resin, p-cresol formaldehyde resin, m-/p-mixed cresol formaldehyde resin, phenol/cresol (any one of m-, p-, and mixed m-/p-) mixed formaldehyde resin, or may be pyrogallol acetone resin. The novolak resin having a phenolic hydroxide group preferably has a weight-average molecular weight of from 500 to 20,000, and a number-average molecular weight of from 200 to 10,000.

As described in the specification of U.S. Pat. No. 4,123,279, there may at the same time be used a condensed compound of formaldehyde and phenol resin having, as a substituent, an alkyl group having 3-8 carbon atoms, such as t-butylphenol formaldehyde resin or octylphenol formaldehyde resin. A single resin having a phenolic hydroxide group maybe used alone, or two or more resins having a phenolic hydroxide group may be used together.

U.S. Pat. No. 6,255,033 (Levanon et al.) describes an acetal resin having phenolic groups. It can be used in the present invention either alone or in combination with other phenolic-containing resins and is suitable for use in the preferred embodiments. The polymer has the advantage that many different functional groups can be incorporated into it to tailor its properties to the specific laser direct imaging application that is needed. Examples of aldehydes that can be used include, for example, acetaldehyde, n-heptaldehyde, 2,4-dihydroxybenzaldehyde, 4-hydroxybenzaldehyde, vanillin, glyoxylic acid and propargyl aldehyde, for example, long chain alkyl aldehydes to reduce the softening point (Tg) of the polymer for ease of lamination for a dry film photoresist or aromatic aldehydes to increase the oleophilicity of the composition for use in a printing plate. The polymer preferably has a molecular weight range from 3,000 to 100,000.

U.S. Pat. No. 6,117,613 describes other suitable polymers for use in a laser direct imaging composition. The alkali aqueous solution soluble polymer compound that has a sulfonamide group as the main functionality may be a monomer of a low molecular weight compound having in the molecule one or more sulfonamide groups in which at least one hydrogen atom is bonded to the nitrogen atom, and one or more unsaturated bonds which can be polymerized. Among these, a preferred choice is a low molecular weight compound having an acryloyl group, allyl group or vinyloxy group, and a substituted or mono-substituted aminosulfonyl group or substituted sulfonylimino group. Specifically, there may be preferably used m-aminosulfonylphenyl methacrylate, N-(p-aminosulfonylphenyl)methacrylamide, or the like.

For a polymer compound having mainly an active imide group, specific examples include N-(p-toluenesulfonyl)methacrylamide or N-(p-toluenesulfonyl)acrylamide.

As the polymer compound (A) in the present embodiment, there may be used not only a polymer compound having, as the main structural unit any of the functional groups previously mentioned, and mixtures of such compounds, but also, as described above, a resin having the phenolic hydroxide group and a copolymerized compound containing, as a copolymerized component, 10 mole % or more of at least one functional group selected from phenolic, sulphonamide or active imino. Specific, preferred examples of such a compound which can be used include N-(4-hydroxyphenyl)acrylamide, N-(4-hydroxyphenyl)methacrylamide, o-hydroxyphenylacrylate, m-hydroxyphenylacrylate, p-hydroxyphenylacrylate, o-hydroxyphenylmethacrylate, m-hydroxyphenylmethacrylate, p-hydroxyphenylmethacrylate, o-hydroxystyrene, m-hydroxystyrene, p-hydroxystyrene, and the like. The copolymer may also contain copolymerized components other than phenolic, sulphonamide or active imino.

Examples of other copolymerized components which may be used are the monomers listed below:

Acrylic esters and methacrylic esters having an aliphatic hydroxyl group such as 2-hydroxyethylacrylate or 2-hydroxyethylmethacrylate, alkyl (meth)acrylates such as methyl acrylate, hexyl acrylate, benzyl acrylate, glycidyl acrylate, methyl methacrylate, butyl methacrylate, cyclohexyl methacrylate, glycidyl methacrylate, and N-dimethylaminoethyl methacrylate, (meth)acrylamides such as acrylamide, methacrylamide, N-methylolacrylamide, N-hexylmethacrylamide, N-hydroxyethylacrylamide, N-phenylacrylamide, vinyl ethers such as ethylvinyl ether, 2-chloroethylvinyl ether, hydroxyethylvinyl ether, and phenylvinyl ether, vinyl esters such as vinyl acetate, vinyl chloroacetate, styrenes such as styrene, .alpha.-methylstyrene, and chloromethylstyrene, vinyl ketones such as methylvinyl ketone and phenylvinyl ketone, olefins such as propylene, isobutylene, butadiene, and isoprene, N-vinylpyrrolidone, N-vinylcarbazole, acrylonitrile, unsaturated imides such as maleimide, N-acryloylacrylamide, and unsaturated carboxylic acids such as acrylic acid, methacrylic acid, maleic anhydride, and itaconic acid.

The polymer compounds described in this specification, whether it is a homopolymer or a copolymer, preferably has a weight-average molecular weight of 2,000 to 300,000, and a dispersion degree (weight-average molecular weight/number-average molecular weight) of from 1.1 to 10.

In the case in which the resin having the phenolic hydroxide group and the aforementioned specific copolymer component form a copolymer, the ratio of the former to the latter is preferably from 50:50 to 5:95, and more preferably from 40:60 to 10:90.

The polymer compound (A) may be used alone or two or more types may be used in combination. The amount thereof is from 30 to 99 weight %, preferably from 40 to 95 weight %, and especially preferably from 50 to 90 weight % of the entire content of solids in the printing plate material. If the added amount of the polymer compound is less than 30 weight %, the durability of the recording layer deteriorates. If the added amount is more than 99% by weight, both the sensitivity and durability deteriorate.

The sensitizing compound, used as component (B), may belong to the following classes:

1. Azo compounds. Examples of this class are:

azonitriles such as substituted valeronitriles and butyronitriles either symmetric or asymmetric. Examples of such compounds are: 2,2′azobis(4-methoxy-2,4-dimethylvaleronitrile), 2,2′-azobis(2,4-dimethyl valeronitrile), 2,2′-azobis (2-methyl propionitrile), 2,2′-azobis(2-methylbutyronitrile), 1,1′-azobis(cyclohexane-1-carbonitrile), 1-(1-cyano-1-methyl)azoformamide, 2-(carbamoylazo)isobutyronitrile etc.

azoamide compounds such as 2,2′-azobis(2-methyl-N-[1,1-bis(hydroxyethyl)-2-hydroxyethyl]propionamide), 2,2′-azobis[2-methyl-N-(2-hydroxyethyl)-propionamide] and others.

azoamidine and cyclic azoamidine compounds such as 2,2′azobis(2-amidinopropane)dihydrochloride, 2,2′-azobis[2-(2-imidazolin-2-yl)propane, 2,2′-azobis[2-(3,4,5,6-tetrahydropyrimidin-2-yl)propane)dihydrochloride and others of similar structure.

other azo compounds such as: 2,2′-azobis(2-methyl propionamide oxime), 4,4′-azobis(4-cyanopentanoic acid), dimethyl 2,2′azobisisobutyrate, azodi-tert-octane as well as macroazocompounds.

2. Peroxy compounds. The following classes of peroxides are examples of useful materials:

diacyl peroxides such as benzoyl peroxide, lauroyl peroxide, decanoyl peroxide, etc.

ketone peroxide and hydroperoxides such as MEK peroxides and hydroperoxides, 2,4-pentanedione peroxides, etc.

di(n-propyl), di(sec-butyl), di(2-ethylhexyl) peroxydicarbonate and others.

peroxyesters such as t-butyl peroxyacetate, t-butyl peroxy-2-ethylhexanoate, t-amyl peroxypivalate, a-cumyl peroxyneoheptanoate and others.

dialkyl peroxides symmetric and asymmetric such as dicumyl peroxide, di-t-amyl peroxide, 2,5-dimethyl-2, 5-di-(t-butyl peroxy) hexyne-3, etc.

alkyl hydroperoxides such as cumene hydroperoxide, t-butyl hydroperoxide, t-amyl hydroperoxide and others.

peroxyketals such as 1,1-di-(tbutylperoxy)-cyclohexane, ethyl 3,3-di(t-amylperoxy)-butyrate and others.

3. Highly exothermic (400-1,500 J/g) and gas producing compounds commonly used as foaming agents in the polyurethane, plastic and cellular rubber industry such as azodicarbonamide, phenyl tetrazole, benzene sulphonyl hydrazide, p-toluene sulfonyl hydrazide, oxibis (benzene sulfonyl hydrazide), p-toluene sulfonyl acetone hydrazone, p-toluene sulfonyl semicarbazide, dinitroso pentamethylenetetramine, 5-phenyl-1H-tetrazole, etc.

4. Highly exothermic (1,000-10,000 J/g) and gas producing compounds that are chemically stable and used commonly as secondary explosives or rocket propellants. Examples are dinitrodimethyloxamide, dinitrodioxyethyloxamide dinitrate, dinitronaphthalene, dipicryl urea, ethylene dinitramine, hexanitrobiphenyl, polyvinyl nitrate, nitrocellulose, etc.

In general, the composition ratio of the component (A) to the component (B) is preferably from 99/1 to 75/25. The sensitizing compound must be present in an amount that is effective to significantly increase the sensitivity of the coating to the developer in the radiation-exposed areas of the coating, that is, increased by an amount useful in the image-forming process. If the amount of component (B) is lower than this lowest limit, the component (B) does not significantly improve the sensitivity of the coating. If the amount of component (B) is more than the aforementioned upper limit, the tolerance to the developer is significantly reduced. Thus, both cases are not preferred.

To provide heat-absorption of the laser energy in the composition of the present invention, a radiation absorbing agent capable of absorbing incident infrared radiation and converting it to heat is preferably incorporated in the coating composition. The radiation absorbing materials suitable for the invented heat-sensitive compositions may be chosen from a wide range of organic and inorganic pigments such as carbon blacks, phthalocyanines or metal oxides. Green pigments: Heliogen Green D8730, D 9360, and Fanal Green D 8330 produced by BASF; Predisol 64H-CAB678 produced by Sun Chemicals, and black pigments: Predisol CAB2604, Predisol N1203, Predisol Black CB-C9558 produced by Sun Chemicals Corp., are examples of effective heat absorbing pigments, and other classes of materials absorbing in the near infrared region are known to those skilled in the art. The infrared absorbing materials are also the preferable heat absorbing agents, which may be used in the compositions of the invention, especially those absorbing at wavelengths longer that 700 nm, such as between about 700 and 1300, with near infrared absorbing materials (between about 700 and 1000 nm) being generally used.

These pigments may be used with or without being subjected to surface treatment. Methods for surface treatment include methods of applying a surface coat of resin or wax, methods of applying surfactant, and methods of bonding a reactive material (for example, a silane coupling agent, an epoxy compound, polyisocyanate, or the like) to the surface of the pigment. These methods for surface treatment are described in “Properties and Application of Metallic Soap” (published by Saiwai Shobo), “Printing Ink Technology” (CMC Publications, published in 1984) and “Latest Pigment Applied Technology” (CMC Publications, published in 1986).

The particle size of the pigments is preferably from 0.01 to 10 um, more preferably from 0.05 to 1 um and especially preferably from 0.1 to 1 um. A particle size of the pigment of less than 0.01 urn is not preferred from the standpoint of the stability of the dispersed pigment in a photosensitive layer coating liquid. A particle size of more than 10 urn is not preferred from the standpoint of uniformity of the formed infrared sensitive layer.

The method for dispersing the pigment in the composition that can be used may be any known dispersion method that is used for the production of ink or toner or the like. Dispersing machines include an ultrasonic disperser, a sand mill, an attritor, a pearl mill, a super mill, a ball mill, an impeller, a disperser, a KD mill, a colloid mill, a dynatron, a three-roll mill and a press kneader. Details thereof are described in “Latest Pigment Applied Technology” (CMC Publications, published in 1986).

For infrared laser sensitive compositions, the dyes that can be used may be any known dyes, such as commercially available dyes or dyes described in, for example, “Dye Handbook” (edited by the Organic Synthetic Chemistry Association, published in 1970). Specific examples of dyes which absorb infrared or near infrared rays are, for example, cyanine dyes disclosed in Japanese Patent Application Laid-Open (JP-A) Nos. 58-125246, 59-84356, 59-202829, and 60-78787; methine dyes disclosed in JP-A Nos. 58-173696, 58-181690, and 58-194595; naphthoquinone dyes disclosed in JP-A Nos. 58112793, 58-224793, 59-48187, 59-73996, 60-52940 and 60-63744; squarylium colorant disclosed in JP-A No. 58-112792; substituted arylbenzo(thio)pyrylium salts described in U.S. Pat. No. 3,881,924; trimethinethia pyrylium salts described in JP-A No. 57-142645 (U.S. Pat. No. 4,327,169); pyrylium-based compounds described in JP-A Nos. 58-181051, 58-220143, 59-41363, 59-84248, 59-84249, 59-146063, and 59-146061; cyanine colorant described in JP-A No. 59-216146; pentamethinethiopyrylium salts described in U.S. Pat. No. 4,283,475; and pyrylium compounds, Epolight 111-178, Epolight 111-130 and Epolight 111-125 described in Japanese Patent Application Publication (JP-B) Nos. 5-13514 and 5-19702 and cyanine dyes disclosed in British Patent No. 434,875.

The pigments or dyes may be added into the material for a printing plate or other compositions such as an etch resist in an amount of from 0.01 to 30 weight %, preferably from 0.1 to 10 weight %, and especially preferably from 0.5 to 10 weight % in the case of the dye and from 3 to 13 weight % in the case of a pigment, with respect to the entire amount of solids in the material for the printing plate. If the pigment or dye content is less than 0.01 weight %, sensitivity is lowered. If this content is more than 30 weight %, uniformity of the photosensitive layer is lost and durability or other properties such as etch resistance of the recording layer deteriorates.

These dyes or pigments may be added into the same layer as the other components, or may be added in a different layer. In the case of using a different layer, the different layer is preferably a layer adjacent to the layer containing the compound of the present embodiment which is thermally decomposable and which substantially lowers the solubility of the binder when the compound is not in a decomposed state. These dyes or pigments and the binder resin are preferably contained in the same layer, but may be contained in different layers.

It is possible that in place of a separate polymer and infrared absorbing compound to have a polymer in which the infrared absorbing material is bonded to the polymer. Examples of these materials are given in U.S. Pat. No. 6,124,425.

A compound that reduces the solubility of the polymer in the alkaline aqueous solution may optionally be included in the coating composition. Such compounds include certain infrared dyes, such as ADS 830A dye (American Dye Source, Montreal, Canada), and certain image colorants, such as Victoria Pure Blue. The use of such compounds is preferred where the inherent solubility of the polymer is relatively high.

In order to achieve stability in processing in a broader range of processing conditions, a surfactant may optionally be included in the compositions of the invention. Suitable nonionic surfactants are described in JP-A Nos. 62-251740 and 3-208514 and amphoteric surfactants described in JP-A Nos. 59-121044 and 4-13149. The amount of the nonionic or amphoteric surfactant is preferably from 0.05 to 10 weight percent and more preferably from 0.1 to 5 weight % of the material for the composition.

A surfactant for improving the applying property, for example, any of the fluorine-containing surfactants such as for example Zonyl's (DuPont) or FC-430 or FC-431 (Minnesota Mining and Manufacturing Co.) or alternatively polysiloxanes such as Byk 333 (Byk Chemie), may be added into the infrared sensitive layer in the present embodiment. The amount of the surfactant added is preferably from 0.01 to 1 weight % and more preferably from 0.05 to 0.5 weight % of the entire material for the composition.

Image colorants may optionally be included in the compositions of the invention in order to provide a visual image on the exposed plate prior to inking. As the image colorant, dyes other than the aforementioned salt-forming organic dyes may be used. Examples of preferred dyes, including the salt forming organic dyes, are oil-soluble dyes and basic dyes. Specific examples are Oil-Yellow #101, Oil Yellow #103, Oil Pink #312, Oil Green BG, Oil Blue BOS, Oil Blue #603, Oil Black BY, Oil Black BS, Oil Black T-505(all of which are manufactured by Orient Chemical Industries Co., Ltd.), Victoria Pure Blue, Crystal Violet (CI42555), Methyl Violet (CI42535), Ethyl Violet, Rhodamine B (CI145170B), Malachite Green (CI42000), Methylene Blue (CI52015), or the like. The dyes described in JP-A No. 62-293247 are especially preferred. The dye may be added into the material for the printing plate in an amount of preferably from 0.01 to 10 weight % and more preferably from 0.5 to 8 weight % of the entire solid contents of the material for the composition.

A plasticizer for providing the formed film with softness may be added as needed in the material for the compositions of the invention. The plasticizer may be e.g. polyethyleneglycol, tributyl citrate, dibutyl phthalate, dioctyl phthalate, tricresyl phosphate, tributyl phosphate, tetrahydrofurfuryl oleate, an oligomer or polymer of acrylic acid or methacrylic acid, or the like, sorbitan tristearate, sorbitan monopalmitate, sorbitan trioleate, monoglyceride stearate, polyoxyethylene-nonylphenylether, alkyldi(aminoethyl)glycine, alkylpolyaminoethylglycine hydrochloride, 2-alkyl-N-carboxyethyl-N-hydroxyethylimidazolium betaine, N-tetradecyl-N,N-betaine (e.g., trade name Amogen, manufactured by Dai-ichi Kogyo Co., Ltd.), and the like.

Other polymers may be added to reduce the cost of the formulation. Examples include urethane and ketone resins such as polyvinyphenyl ketones. The amounts of these materials can vary between 0.5% and 25%, preferably between 2% and 20% by weight of solids.

Suitable adhesion promoters may optionally be included in the compositions of the invention. Suitable ones include di-acids, triazoles, thiazoles and alkyne containing materials. The adhesion promoters are used in amounts between 0.01 and 3% by weight.

The image recording material according to the invention can be produced by dissolving the aforementioned respective components into an appropriate solvent, filtering if necessary, and applied from a liquid in a manner known, for example, bar coater coating, spin coating, rotating coating, curtain coating, dip coating, air knife coating, blade coating, and roll coating, or the like. The solvent used herein may be methylenechloride, ethylenedichloride, cyclohexanone, methylethyl ketone, acetone, methanol, propanol, ethyleneglycolmonomethylether, 1-methoxy-2-propanol, 2-methoxyethyl acetate, 1-methoxy-2-propyl acetate, dimethoxyethane, methyl lactate, ethyl lactate, and toluene or the like. However, the solvent is not limited to these examples. A single solvent may be used alone, or a combination of two or more solvents may be used. The concentration of the aforementioned components (all of the solid components including the additives) in the solvent is preferably from 1 to 50 weight %. The applied amount (of the solid) on the substrate obtained after application and drying differs in accordance with the use, but in general, is preferably from 0.3 to 12.0 g/m.sup.2 according to the application. Lesser amounts can be applied to the substrate, resulting in a higher apparent sensitivity, but the film characteristics of the material are deteriorated.

The thermally-sensitive compositions of this invention are useful for production of printing circuit boards, for lithographic printing plates and other heat-sensitive elements suitable for direct imaging, including but not limited to laser direct imaging (LDI). Suitable substrates may include, for example, paper; paper on which plastic such as polyethylene, polypropylene, polystyrene or the like is laminated; a metal plate such as an aluminum, zinc or copper plate; a copper foil, reverse treated copper foil, drum side treated copper foil and double treated copper foil clad on a plastic laminate, a plastic film formed of, for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, or polyvinyl acetal; a paper or a plastic film on which the aforementioned metal is vapor-deposited or laminated; glass or glass in which a metal or metal oxide is vapor deposited or the like.

As the substrate in the present embodiment for a printing plate, a polyester film, or an aluminum plate is preferred, and an aluminum plate is especially preferred because of its stable dimensions and relatively low cost. A plastic film on which aluminum is laminated or vapor-deposited may be used. The composition of the aluminum plate applied to the present invention is not specified, and the aluminum plate may be prepared according to any of the known methods, for example of roughening, anodizing and post anodizing treatments. The thickness of the aluminum plate used in the present embodiment is from about 0.1 to 0.6 mm, preferably from 0.15 to 0.5 mm.

The positive image recording material produced as described above is usually subjected to image-exposure and developing processes.

In a preferred embodiment, radiation-sensitive compositions as described above are applied as a coating on a lithographic base (for example an aluminum plate) to form a lithographic printing precursor. The precursor can be imaged (for example by imagewise exposure to infrared radiation), and the imaged precursor developed to a positive-working lithographic printing plate, using a conventional alkaline aqueous developer solution.

In the preferred embodiment of the invention, the light source for an active light beam which is used in the image-exposure, is preferably a light source emitting light having a luminous wavelength within the range from the near infrared wavelength region to the infrared wavelength region, and is especially preferably a solid state laser or a semiconductor laser. In a more general embodiment of the present invention, there is no limitation on the wavelength or nature of the radiation source and suitable radiation absorbing agents may be chosen to match the wavelength of the radiation source.

The developing solution and replenishing solution for the image recording material of the present embodiment may be a conventionally known alkali aqueous solution such as, for example, sodium metasilicate, potassium tertiary phosphate, ammonium secondary phosphate, sodium carbonate, potassium borate, sodium hydroxide, ammonium hydroxide, potassium hydroxide, tetraalkylammonium hydroxides; and organic alkali agents such as, alkyl amines, alkyl ethanolamines or diamines. The alkali agent may be used alone, or a combination of two or more may be used.

Among these, especially preferred developing solutions are aqueous solutions of silicates and hydroxides. It is known that when development is carried out by using an automatic developing machine, an aqueous solution (a replenishing solution) having a higher basicity than that of the developing solution is added to the developing solution so that many plates or pieces of can be processed without having to replace the developing solution in the developing tank for a long time. In the present embodiment, such a replenishing manner is preferably used. Various surfactants or organic solvents may be optionally added to the developing solution and the replenishing solution to accelerate or control developability, improve the dispersibility of development-scum, and/or improve the affinity of image portions on the printing plate with ink. Other agents commonly used in positive plate developers may also be included in the developer solution.

The composition is usually post-processed with water; optionally containing, for example, a surfactant. In the case of printing plates a desensitizing solution containing gum arabic or a starch derivative is used. Various combinations of these treatments can be used as the post-processing carried out when the image recording material of the present embodiment is used in its different applications.

The following examples illustrate aspects of the invention. Materials were obtained from the following sources:

Mowiol 3-83, a polyvinyl acetate product from Hoechst, Germany. Methanol, sulphuric acid and propyleneglycol monomethylether (Dowanol PM), sodium carbonate, sodium sulphate, ammonia, chlorine were obtained from VWR Canlab, Mississauga, Ontario, Canada.

Butyraldehyde, acetone, benzene, cyanohydrin, ethylhydrazine monocarbonate, 3-hydroxy-benzaldehyde, methyl violet, trimethyl orthoformate, sodium metasilicate, 2,6 di-t-butyl-4-methylphenol, 5-phenyltetrazole and dicumyl hydroperoxide were obtained from Sigma-Aldrich Canada, Oakville, Ontario, Canada.

Tween 80K from Avecia of Manchester, UK.

ADS830A IR dye from American Dye Source, Montreal, Canada.

214-naphthaquinone diazide from St. Jean Chemicals, Quebec, Canada.

LB744 novolak resin from Bakelite, Germany.

### EXAMPLE 1

110 grams of Mowiol 3-83 polyvinyl alcohol (an 83% hydrolyzed polyvinyl acetate having a number average molecular weight of about 14,000), was added to a closed reaction vessel fitted with a water-cooled condenser, a dropping funnel and thermometer, containing 110 grams of demineralized water and 110 grams of methanol. With continual stirring, the mixture was heated for 0.5 hour at 80° C. until became a clear solution. After this the temperature was adjusted to 60° C. and 3 grams of concentrated sulfuric acid in 100 grams of propyleneglycol monomethylether (PM) was added. Over a 15 minutes period, a solution of 65 grams of 3-hydroxybenzaldehyde and 1.4 grams of 2,6-di-t-butyl-4-methylphenol in 450 grams of PM was added in a dropwise manner. The reaction mixture was diluted with additional 200 grams of PM, and 9.2 grams of n-butyraldehyde in 200 grams of PM was added in a dropwise manner, upon complete addition of the aldehydes, the reaction was continued at 50° C. for additional 3 hours. At this stage the conversion of the butyraldhyde is completed and the conversion of the 3-hydroxybenzaldehyde is close to 50%. 500 grams of trimethyl orthoformate was added to the reaction mixture in a dropwise manner under stirring. After addition of the trimethyl orthoformate the conversion of 3-hydroxybenzaldehyde reached 100% (less then 0.1% of water in the reaction mixture). The resultant polymer is called Polymer A in subsequent examples.

### EXAMPLE 2

To 85 g of acetone cyanohydrin, 140 g of ethyl hydrazine monocarbonate was added. Crystallization occurred after the mixture was heated at 60° C. for 90 minutes. Recrystallization of the crude product in methanol afforded 181 g of 2-ethylhydrazidemonocarbonate isobutyronitrile (also referred to herein as Compound 1) (m.p. 117° C.).

On an ice bath, 100 g of Compound 1 was introduced into a mixture of 150 mL water and 500 mL benzene. The reaction mixture was maintained at 0 to 5° C. and was gently treated with chlorine gas until a clear solution was obtained. The yellow benzene portion was separated and washed several times with sodium carbonate followed by water. The solution was then dried with sodium sulfate. Removal of benzene under reduced pressure at <50° C. gave rise to 98 g of an oily product, 2-(ethylmonocarbonateazo) isobutyronitrile (also referred to herein as Compound 2).

85 g of Compound 2 was treated with ammonia. The reaction is exothermic and the vessel was cooled to ensure the temperature was below 50° C. When the reaction stopped, 2-(carbamoylazo)isobutyronitrile (also referred to herein as Compound 3) (m.p. 81° C.) crystallized out upon evaporation of ethanol. Recrystallization in methanol afforded 68 g of pure Compound 3.

### EXAMPLE 3

8.8 grams of Polymer A, 1 g of 5-phenyl-1H-tetrazole, 0.1 g ADS 830A IR dye, 0.3 g Tween 80K and 0.8 g methyl violet were dissolved in 10 g Dowanol PM. The coating was cast onto anodised aluminum substrate using a wire wound rod #11 and the plate dried at 135° C. for 90 seconds. The resultant dry coating weight was about 1.8 g/m². The plate was exposed imagewise using a Creo Inc. Trendsetter image setter with a power of 12 watts. The plate was then developed in an alkaline solution containing 8% sodium. The exposure energy needed to obtain satisfactory development was 60 mJ/cm².

### EXAMPLE 4

The same composition as in Example 3 was made up with the exception that Compound 3 was added in a proportion of 10% to the polymer in place of 5-phenyl-1H-tetrazole. The coating was cast onto anodised aluminum substrate using a wire wound rod #11 and the plate dried at 135° C. for 90 seconds. The resultant dry coating weight was about 1.8 g/m². The plate was exposed imagewise using a Creo Inc. Trendsetter with a power of 12 watts. The plate was then developed in an alkaline solution containing 8% sodium metasilicate. The exposure energy needed to get satisfactory development was 180 mJ/cm².

### EXAMPLE 5

The same coating composition as in Example 3 was used with the exception that 5% dicumyl peroxide was added in place of 5-phenyl-1H-tetrazole. The coating was cast onto anodised aluminum substrate using a wire wound rod #11 and the plate dried at 135° C. for 90 seconds. The resultant dry coating weight was about 1.8 g/m2. The plate was exposed imagewise using a Creo Inc Trendsetter with a power of 15 watts. The plate was then developed in an alkaline solution containing 8% sodium. The exposure energy needed to get satisfactory development was 200 mJ/cm2.

Example 6 illustrates a non-infrared imaging formulation of the invention.

### EXAMPLE 6

8.5 g LB744 novolak resin was dissolved in 90 g Dowanol PM. 1 g 214 naphthaquinone diazide, 1 g Compound 3 and 0.3 g methyl violet were added and the mixture stirred until all of the components had dissolved. The solution was coated onto anodized aluminum using a #11 wire wound rod and dried in an oven for 3 minutes at 125° C. The plate was then exposed to UV light in a printing down frame using a variety of exposures from 20 to 80 seconds with 10 second intervals of exposure time. The plate was developed in a sodium metasilicate solution. The exposure time needed to get satisfactory development was determined to be 40 seconds.

COMPARATIVE EXAMPLE 7

8.5 g LB744 was dissolved in 90 g Dowanol PM. 1 g 214 naphthaquinone diazide and 0.3 g methyl violet were added and the mixture stirred until all of the components had dissolved. The solution was coated onto anodized aluminum using a #11 wire wound rod and dried in an oven for 3 minutes at 125° C. The plate was then exposed to UV light in a printing down frame using a variety of exposures from 20 to 80 seconds with 10 second intervals of exposure time. The plate was developed in a sodium metasilicate solution. The exposure time needed to get satisfactory development was determined to be 50 seconds.

### COMPARATIVE EXAMPLE 8

8.8 g Polymer A, 0.1 g ADS 830A IR dye, 0.3 g Tween 80K and 0.8 g methyl violet were dissolved in 100 g Dowanol PM. The coating was cast onto anodised aluminum substrate using a wire wound rod #11 and the plate dried at 135° C. for 90 seconds. The resultant dry coating weight was about 1.7 g/m². The plate was exposed imagewise using a Creo Inc. Trendsetter with a power of 12 watts. The plate was then developed in an alkaline solution containing 8% sodium metasilicate. An energy of 500 mJ/cm² was needed to get satisfactory development of the plate.

The present invention provides novel positive-acting imageable compositions and elements and has advantages in that the image forming capability of a recording layer comprising a polymer compound is improved, places in which the composition can be handled are not restricted, handling of the composition is easy because of the stability of the state before development, and the development latitude is good.

There have thus been outlined the important features of the invention in order that it may be better understood, and in order that the present contribution to the art may be better appreciated. Those skilled in the art will appreciate that the conception on which this disclosure is based may readily be utilized as a basis for the design of other methods and apparatus for carrying out the several purposes of the invention. It is most important, therefore, that this disclosure be regarded as including such equivalent methods and apparatus as do not depart from the spirit and scope of the invention.

What is claimed is:

1. A positive-working radiation-imageable composition comprising:
(a) a polymer capable of being dissolved in an alkaline aqueous solution; and
(b) a sensitizing compound that is gas-forming upon being heated, and thereby increases the rate at which said polymer can dissolve in said solution.

2. A composition according to claim 1 wherein said sensitizing compound is an azo compound or peroxy compound.

3. A composition according to claim 1 wherein the weight ratio of said polymer to said sensitizing compound is in the range of 99:1 to 75:25.

4. A composition according to claim 1 wherein said sensitizing compound is not one of quinone diazide and an onium salt.

5. A composition according to claim 1 further including a converter substance capable of converting radiation into heat.

6. A composition according to claim 1 wherein said radiation is light.

7. A composition according to claim 1 wherein said radiation is infrared.

8. A composition according to claim 1 wherein said polymer is a polymer having one of a phenolic hydroxide group, a sulfonamide group and an active imide.

9. A composition according to claim 1 wherein said polymer is an acetal resin.

10. A composition according to claim 1 wherein said polymer has a weight-average molecular weight in the range of 2,000 to 20,000.

11. A composition according to claim 1 further comprising a compound that reduces the solubility of said polymer in said solution.

12. A composition according to claim 11 wherein said solubility-reducing compound is one of an infrared dye and an image colorant.

13. A composition according to claim 12 wherein said solubility reducing compound is Victoria Pure Blue.

14. A composition according to claim 5 wherein said converter substance is an infrared dye.

15. A composition according to claim 5 wherein said converter substance is present in an amount in the range of 0.01 to 30 weight percent.

16. A composition according to claim 5 wherein said composition comprises a coating having more than one layer and said converter substance is present in a different layer from said polymer and said sensitizing compound.

17. A composition according to claim 1 further comprising a surfactant.

18. A composition according to claim 1 further including an image colorant.

19. A composition according to claim 1 further including a plasticizer.

20. A composition according to claim 1 further including an adhesion promoter.

21. A composition according to claim 1 applied as a coating on a substrate.

22. A positive-working lithographic printing precursor developable using an alkaline aqueous solution, comprising:
(a) a lithographic base; and
(b) a radiation-sensitive coating on a surface of said base, said coating comprising:
(i) a polymer capable of being dissolved in said alkaline aqueous solution; and
(ii) a sensitizing compound that is gas-forming upon being heated, and thereby increases the rate at which said polymer can dissolve in said solution.

23. A method for making a positive-working lithographic printing master, comprising the steps of:
(a) imagewise exposing to radiation a thermally convertible lithographic printing precursor comprising:
(i) a lithographic base; and
(ii) a radiation-sensitive coating on a surface of said lithographic base, said coating comprising:
(1) a polymer capable of being dissolved in an alkaline aqueous solution; and
(2) a sensitizing compound that is gas-forming upon being heated, and thereby increases the rate at which said polymer can dissolve in said solution,
said step of imagewise exposing resulting in parts of said coating being irradiated and parts of said coating not being irradiated; and
(b) developing said exposed lithographic printing precursor with said solution in order to remove said unirradiated parts of said coating.
